(19) United States
(12) Patent Application Publication
(10) Pub. No.: US 2005/0040257 A1
(43) Pub. Date: Feb. 24, 2005

(54) Atomizer with dedicated cleaning fluid system

(76) Inventor: David M. Seitz, Riga, MI (US)

Correspondence Address: LISA M. SOLTIS;ILLINOIS TOOL WORKS INC., 3600 WEST LAKE AVENUE, GLENVIEW, IL, 60025, US

(21) Appl. No.: 10/643,393

(22) Filed: Aug. 19, 2003

(51) Int. Cl. B05B 3/00; B05B 1/34; B05B 1/32

(52) U.S. Cl. 239/451; 239/457; 239/380

(57) ABSTRACT

A cleaning system is provided for a rotary atomizing applicator. An axial passage from an air turbine into the bell cup of the atomizer is provided with formations to improve the transport of cleaning fluid into the bell cup. An orifice directs a fan-shaped spray of cleaning fluid at the outer surface of the bell cup. The inner and outer surfaces of the bell cup are cleaned while the bell cup is rotating.

### FIELD OF THE INVENTION

The present invention relates generally to coating applicators and, more particularly, the present invention relates to cleaning systems for rotary atomizing applicators used to apply paint and other coatings.

### BACKGROUND OF THE INVENTION

It is known to use automated spray applicators to apply coatings of various types on objects during manufacture. Automobile vehicle bodies commonly are coated using robotic devices with spray applicators. The robot is programmed to perform a sequence of maneuvers and adjustments so that the vehicle body pieces are adequately and precisely covered in a rapid procedure with minimal waste.

To reduce the amount of over spray and further reduce waste, it is known to use atomizing applicators. A bell cup rotates at high speed, and the coating material, such as paint, is provided to the inside of the cup. As the paint or other coating moves outwardly and off the cup surface as a result of centrifugal force, the coating is atomized into a fine mist and directed at the object to be coated. It is known to use shaping air streams to confine and direct the atomized coating toward the object. It is also known to charge the atomized mist with electrical potential and to ground the object being coated so that the coating material is attracted to the object, further reducing over spray and improving coverage on irregularly shaped target objects.

In present day manufacturing procedures, such as for automobile vehicle bodies, it is common to have parts in random color sequences advancing along a manufacturing line. Thus, for each object to be coated it may be necessary to change the color of paint or other coating used from that used for the previous object. To ensure purity of the coating to be applied, it is necessary to clean at least parts of the coating applicator when a change is made. It is also necessary to routinely clean the atomizer for continued proper operation, even when only a single type of coating is applied to all objects.

Both the inside and the outside of the bell cup require periodic cleaning. The inside of the bell cup receives the coating material for atomizing, and must be cleaned whenever a coating change is made to avoid contamination of the new coating with residual amounts of the previous coating. A variety of systems are known for cleaning the inside of the bell cup, some more effective and more efficient than others are.

The outside surface of the bell cup is not directly involved in the atomization process, but also can become covered with coating material from the airborne mist in the coating booth. These residual amounts of coating, if allowed to accumulate, can contaminate subsequent coatings and can adversely affect operation of the applicator. It is known to provide a cleaning station, and to move the applicator to the cleaning station at set intervals to clean the back of the cup. Moving to a dedicated cleaning location can be time-consuming, and cleaning at a cleaning station can be wasteful of cleaner.

It is desirable to minimize the time needed for cleaning. Parts moving along a manufacturing line may be spaced by intervals of only a few seconds, and it is desirable to clean and prepare the applicator within the normal separation time so that the cleaning operation does not slow the overall speed of the line and reduce productivity. It also is desirable to minimize as much as possible the volume of cleaning agents required. For many coatings, the cleaning agents are considered hazardous waste and must be properly handled for disposal. Decreasing the time required for cleaning and reducing the amount of cleaning agent required can significantly decrease costs and increase productivity of a coating operation.

What is needed in the art is a simple yet effective system for efficiently and effectively cleaning both the inside and the outside of a bell cup in an atomizing applicator.

### SUMMARY OF THE INVENTION

The present invention provides an efficient cleaning system for a bell cup in an atomizing applicator, including a channel through the rotating shaft with grooves or rifling to positive transport cleaning agent therethrough, and a spray nozzle depositing cleaning fluid on the back of the rotating bell cup.

In one aspect thereof, the present invention provides a rotary atomizer for a coating material applicator with a rotating element having a longitudinal opening therethrough and a bell cup connected to the rotating element for rotation therewith. The bell cup has inner and outer edges, an outer surface and an inner surface receiving coating material to be atomized. The inner surface is open to the longitudinal opening in the rotating element. A cleaning fluid conduit is in flow communication with the longitudinal opening in the rotating element, and a flow enhancing formation is defined in the longitudinal opening to improve transport of cleaning fluid along the longitudinal opening.

In another aspect thereof, the present invention provides a cleaning system for a rotary atomizer having a bell cup on a rotating element and an axial opening from the rotating element into the bell cup. The cleaning system has a cleaning fluid conduit in flow communication with the opening, and a flow enhancing formation defined in the opening to improve transport of cleaning fluid along the opening from the cleaning fluid conduit to the bell cup as the rotating element rotates. An orifice behind the bell cup is directed at an outer surface of the bell cup, and a cleaning fluid conduit is in flow communication with the orifice.

In still another aspect thereof, the present invention provides a method for cleaning a rotary atomizing applicator having a bell cup connected to a rotating element. The method has steps of providing a longitudinal opening from the rotating element into the bell cup and a formation on the surface of the opening to transport cleaning fluid therealong; rotating the rotary atomizing head; dispensing cleaning fluid into the longitudinal opening; transporting the cleaning fluid into the bell cup using the formation; and spraying cleaning fluid against an outer surface of the bell cup.

An advantage of the present invention is providing an efficient cleaning fluid transport structure through the rotating turbine shaft of an atomizing applicator.

Another advantage of the present invention is providing a system to effectively clean both the outside surface and the inside surface of the bell cup in an atomizing applicator.

Still another advantage of the present invention is providing an onboard cleaning system for an atomizing applicator that thoroughly cleans the critical applicator surface in position, without requiring a separate cleaning station.

A further advantage of the present invention is providing a cleaning system for an atomizing applicator that operates quickly, without delaying manufacturing line performance.

A still further advantage of the present invention is providing a cleaning system for an atomizing applicator that reduces waste of coating material, and decreases the volume of cleaning fluid required, as compared to other cleaning systems.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a rotary atomizing applicator having a cleaning system in accordance with the present invention;

FIG. 2 is an enlarged elevational view of a turbine assembly in accordance with the present invention;

FIG. 3 is a cross sectional view of the turbine assembly shown in FIG. 2, the cross section having been taken along line 3-3 of FIG. 2;

FIG. 4 is a cross sectional view of the applicator shown in FIG. 1; and

FIG. 5 is an enlarged perspective view of the cleaning system for the outside of the bell cup in operation.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

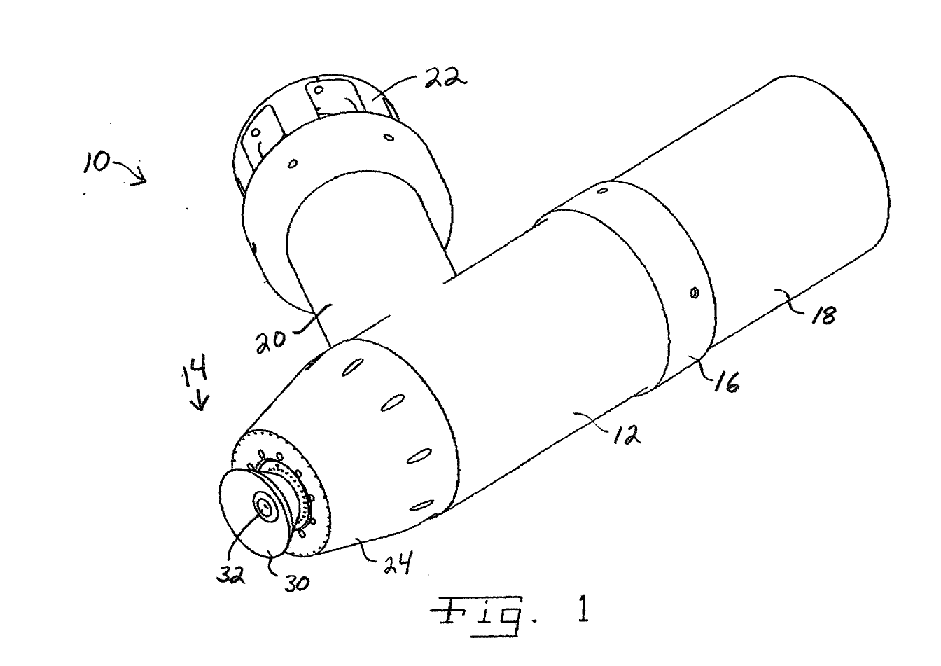

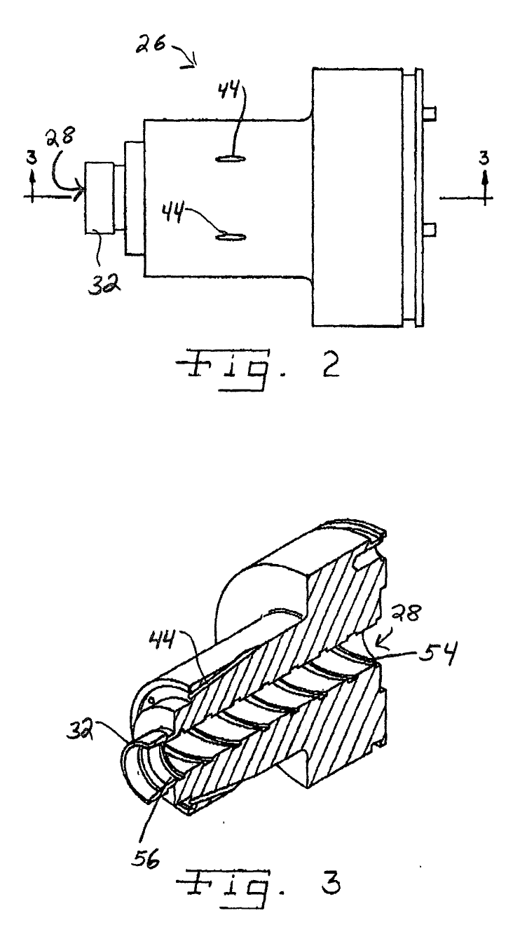

Referring now more specifically to the drawings and to FIG. 1 in particular, a rotary atomizing coating applicator 10 in accordance with the present invention is shown. As those skilled in the art will understand readily, applicator 10 is mounted on and operated by a robot (not shown) for performing a controlled series of maneuvers to properly and consistently coat a series of objects in a manufacturing process. For example, such applicators are used to paint automobile vehicle body parts. However, applicators of this type also can be used for coating a variety of different objects with paint and other coatings. It should be further understood that the present invention works well with different styles and types of applicators, and applicator 10 shown is merely one example of such a device.

Applicator 10 includes a main body portion 12, and an atomizing head 14 provided on one end of main body 12. A canister-docking fixture 16 is provided on an opposite end of main body 12. A canister 18 is connected to fixture 16 and provides a supply of coating material to be applied by applicator 10. It should be understood that other types of coating material supplies can be used for providing coating material to applicator 10, and the present invention is not limited to an applicator 10 having canister fixture 16 and canister 18. For example, applicator 10 can include connections to sources of a variety of coatings, or can include detachable sources other than canister 18

Applicator 10 further includes a connector arm 20 by which various electrical, air and/or other systems and supplies are connected to or from a robot (not shown) for operation of applicator 10. A robot adapter 22 is provided for connection to the robot (not shown). For example, arm 20 can include connections to sources of pressurized air to operate rotary power apparatus to be described subsequently, and to shape and direct the atomized mist being applied on an object. Electrical systems, solvent or cleaning fluid supplies and other systems also can be connected through arm 20.

Atomizing head 14 includes a shroud 24 connected to main body portion 12. Shroud 24 covers a rotating element, such as an air motor or turbine assembly 26 and other components at the front end of applicator 10. Turbine assembly 26 defines a longitudinal opening 28 therethrough. A coating material supply tube (not shown) from canister 18 or from another source of coating material extends through opening 28 to supply coating material for application. A rotary bell cup 30 is disposed on a shaft-like end 32 of turbine assembly 26. The interior of bell cup 30 is open to longitudinal opening 28 in turbine assembly 26. Turbine assembly 26 and bell cup 30 connected thereto are rotated at high speed during operation of applicator 10. The manner in which applicator 10 functions in applying a coating, and the manner in which bell cup 30 operates on coating material supplied thereto to atomize the coating are well-known to those skilled in the art and will not be described in further detail herein.

Shroud 24 is of a generally frustoconical shape, having a side wall 36 and an end wall 38 defining a hole 40 through which shaft-like end 32 extends. As known to those skilled in the art, shroud 24 and defines inner and outer patterns of pluralities of shaping air nozzles 44 and 46, respectively, at end wall 38. Pressurized air flows from shaping air nozzles 44 and 46 for directing the atomized mist of coating material provided from bell cup 30. The shaping air streams from shaping air nozzles 44 flow generally along the outer edge of bell cup 30 to influence the atomized mist forwardly from bell cup 30.

Bell cup 30 includes an inner surface 48 on which coating material is received for the atomization thereof in a manner well-known to those skilled in the art. Inner surface 48 can retain residual amounts of coating material thereon after completion of a coating operation. Bell cup 30 further defines an outer surface 50 at the back thereof, in front of shroud 24. Coating material can accumulate on outer surface 50 during a coating operation from coating material mist present around applicator 10.

For cleaning inner surface 48 of bell cup 30, cleaning fluid is provided to longitudinal opening 28 via a conduit 52 in flow communication therewith, conduit 52 also being connected to a cleaning fluid supply, which may be through connector arm 20 and adapter 22. Cleaning is performed with turbine assembly 26 rotating, and only a small volume of cleaning fluid is required. To improve transport of cleaning fluid along opening 28, the inner surface defining opening 28 is provided with at least one or several flow enhancing formations such as helical grooves or rifling grooves 54. Grooves 54 angle from an outer end 56 of opening 28 counter to the direction of rotation of turbine assembly 26. Cleaning fluid is thereby transported forwardly within opening 28 and into bell cup 30 on inner surface 48. The cleaning fluid is dispersed evenly on inner surface 48 by centrifugal force, and the cleaning fluid flows over surface 48 outwardly to an outer edge 58 of bell cup 30, removing any residual coating material therewith.

Internal cup cleaning can be performed with or without a coating material supply tube (not shown) positioned within longitudinal opening 28. If a tube is present, cleaning fluid can still be transported along opening 28 in groove 54.

For cleaning outer surface 50, one or more cleaning fluid orifices 60 are provided behind bell cup 30, one such orifice 60 being shown in the drawings. Cleaning fluid is provided to orifice 60 via a conduit 62 connected to a cleaning fluid supply, which may be through connector arm 20 and adapter 22. Cleaning is performed with turbine assembly 26 rotating, and only a small volume of cleaning fluid is required. A fan-like spray 64 of cleaning fluid (FIG. 5) is emitted against outer surface 50 of bell cup 30, nearer to an inner edge 66 than to outer edge 58 of bell cup 30. Centrifugal force from rotating bell cup 30 disperses the cleaning fluid over outer surface 50, and outwardly from inner edge 66 to outer edge 58.

Fan-like spray 64 spreads the cleaning fluid more evenly on outer surface 50 than would a more concentrated, jet-like spray. The pattern of fan-like spray 64 can be adjusted for different size bell cups 30 by varying the pressure of the cleaning fluid supplied to orifice 60. Advantageously, fan-like spray 64 is deposited on outer surface 50 radially inwardly of outer shaping air nozzles 46, and the patterned shaping air holds the cleaning fluid against outer surface 50.

The present cleaning system allows for thorough, efficient cleaning without the need to supply a cleaning station, and without the added delay of moving applicator 10 to a cleaning station or moving a cleaning station to applicator 10. Only a small volume of cleaning fluid is required, and the surfaces are cleaned thoroughly by taking advantage of the same forces for cleaning as are used in the atomization spraying process. Periodic cleaning is needed to remove dried coating material even when only a single coating type is used. The present cleaning system does not waste coating material in that it is not necessary to evacuate a coating material supply tube for the purpose of transporting cleaning fluid therethrough. Less cleaning fluid is required in that the tube is not cleaned needlessly. The present system can be used with a coating material supply tube remaining full of coating material.

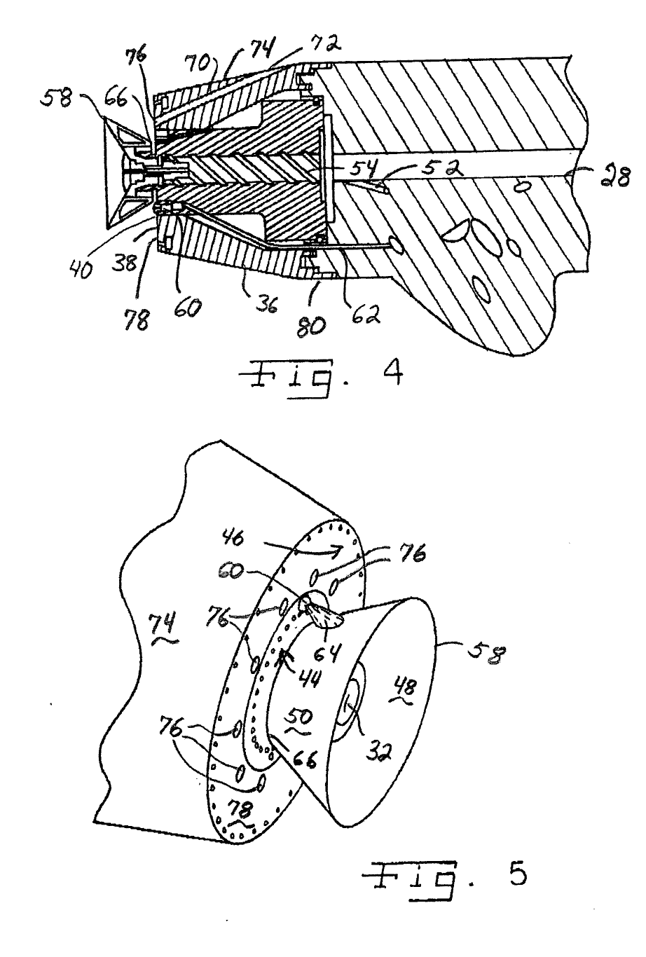

Advantageously, shroud 24 is further provided with a plurality of passages 70 (FIG. 4) extending therethrough, each having a first opening 72 on a side surface 74 of shroud side wall 36, and a second opening 76 for each passage 70 provided on a front face or end surface 78 of shroud 24. First openings 72 of passages 70 are provided well rearward from end surface 78, near a rear edge 80 of shroud 24 opposite from end wall 38. With shroud 24 having a generally tapered, somewhat funnel-like or frustoconical shape, first openings 72 are provided at or near a major diameter of shroud 24. Second openings 76 are positioned near hole 40 defined in end 38, through which turbine shaft 32 extends. Second openings 76 are positioned radially inward from the pattern of outer shaping air nozzles 46, between hole 40 and the pattern of shaping air nozzles 46. Second openings 76 are located within the normally low-pressure area created behind bell cup 30 during operation of applicator 10.

Passages 70 angle inwardly from first openings 72 thereof to second openings 76 thereof, extending within the thickness of side wall 36. Passages 70 are generally smooth and provide minimal restriction to the flow of air therethrough. In the exemplary embodiment shown in the drawings, shroud 24 is provided with ten passages 70; however, it should be understood that more or fewer passages 70 can be used. If wider passages 70 are used, fewer may be required than if narrower passages 70 are used.

As bell cup 30 rotates at high speed for the atomization of coating material being applied, or during a cleaning operation, a pumping effect is created which removes air and creates a low-pressure area immediately behind bell cup 30. As a result of the reduced pressure in the area behind bell cup 30, ambient air flows naturally through passages 70, without the need for pumping or pressurization. Passages 70 need not be connected to a supply of pressurized air, other than being exposed and open to ambient air immediately surrounding applicator 10. Ambient air enters at first openings 72 and exits at second openings 76. Air flowing through passages 70 “fills” the low-pressure area behind bell cup 24. During cleaning, the reduction or elimination of the low-pressure area behind bell cup 30 reduces any tendency for cleaning fluid to fly off from outer surface 50, and the cleaning of outer surface 50 is made more effective and more efficient.

Since first openings 72 through which air enters and flows through passages 70 are provided well behind bell cup 24 and at an outer position on shroud 24 remote from atomizing head 14, the air drawn through passages 70 is substantially free from atomized coating material and other contaminants. Thus, relatively “clean” air is provided to fill the normally low pressure area behind bell cup 30. Outer surface 50 of bell cup 30 is maintained in a relatively clean condition, thereby reducing the frequency of required cleanings of the outside of the bell cup, and reducing the use of cleaning fluids. Since atomized coating material mist and/or shaping air is not drawn into the low pressure area behind bell cup 30, each operates more efficiently as intended, and the coating material is directed more precisely at the object to be coated. Therefore, less coating material is wasted, and higher coating efficiencies may result.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A rotary atomizer for a coating material applicator, said atomizer comprising:
a rotating element having a longitudinal opening therethrough;
a bell cup connected to said rotating element for rotation therewith, said bell cup having inner and outer edges, an outer surface and an inner surface receiving coating material to be atomized, said inner surface being open to said longitudinal opening in said rotating element;
a cleaning fluid conduit in flow communication with said longitudinal opening in said rotating element; and
a flow enhancing formation defined in said longitudinal opening to improve transport of cleaning fluid along said longitudinal opening.

2. The rotary atomizer of claim 1, said flow enhancing formation being a groove in a surface defining said longitudinal opening.

3. The rotary atomizer of claim 2, said groove being helical.

4. The rotary atomizer of claim 1, including an orifice behind said bell cup directed at said outer surface, and a cleaning fluid conduit in flow communication with said orifice.

5. The rotary atomizer of claim 4, said flow enhancing formation being a groove in a surface defining said longitudinal opening.

6. The rotary atomizer of claim 4, said flow enhancing formation being a helical groove in a surface defining said longitudinal opening.

7. The rotary atomizer of claim 4, said orifice directed at an area nearer to said inner edge than to said outer edge of said bell cup.

8. The rotary atomizer of claim 4, said orifice configured to direct a fan-shaped spray at said outer surface.

9. The rotary atomizer of claim 8, said orifice directed at an area nearer to said inner edge than to said outer edge of said bell cup.

10. The rotary atomizer of claim 9, said flow enhancing formation being a groove in a surface defining said longitudinal opening.

11. The rotary atomizer of claim 10, said groove being helical.

12. A cleaning system for a rotary atomizer having a bell cup on a rotating element and an axial opening from the rotating element into the bell cup, said cleaning system comprising:
a cleaning fluid conduit in flow communication with the opening;
a flow enhancing formation defined in the opening to improve transport of cleaning fluid along the opening from said cleaning fluid conduit to the bell cup as the rotating element rotates;
an orifice behind the bell cup directed at an outer surface of the bell cup; and
a cleaning fluid conduit in flow communication with said orifice.

13. The cleaning system of claim 12, said flow enhancing formation being a groove.

14. The cleaning system of claim 13, said groove being helical.

15. The cleaning system of claim 12, said orifice configured to direct a fan-shaped spray at the outer surface of the bell cup.

16. The cleaning system of claim 15, said orifice configured to direct said fan-shaped spray in an area nearer to an inner edge of the bell cup than to an outer edge of the bell cup.

17. A method for cleaning a rotary atomizing applicator having a bell cup connected to a rotating element, said method comprising steps of:
providing a longitudinal opening from the rotating element into the bell cup, and a formation on the surface of the opening to transport cleaning fluid therealong;
rotating the rotary atomizing head;
dispensing cleaning fluid into the longitudinal opening;
transporting the cleaning fluid into the bell cup using the formation; and
spraying cleaning fluid against an outer surface of the bell cup.

18. The method of claim 17, including spraying the cleaning fluid against the outer surface in a fan-shaped spray.

19. The method of claim 18, including spraying the cleaning fluid against the outer surface in an area nearer to an inner edge of the bell cup than to an outer edge of the bell cup.

20. The method of claim 17, including spraying the cleaning fluid against the outer surface in an area nearer to an inner edge of the bell cup than to an outer edge of the bell cup.
